(19) United States
(12) Patent Application Publication
(10) Pub. No.: US 2017/0144683 A1
(43) Pub. Date: May 25, 2017

(54) CONTAINER WITH ALL TERRAIN CAPABILITY

(71) Applicant: Harry Randy Moskovsky, Fort Myers, FL (US)

(72) Inventor: Harry Randy Moskovsky, Fort Myers, FL (US)

(21) Appl. No.: 14/949,050

(22) Filed: Nov. 23, 2015

(51) Int. Cl. B62B 1/24; B62B 1/20; B65D 81/38

(52) U.S. Cl. CPC B62B 1/24; B65D 81/3813; B62B 1/208

(57) ABSTRACT

Movable containers for transporting materials using the motive power of a person are described. The containers include a recess at a bottom end thereof that may extend substantially along a width of the container. An elongated roller is partially located within the recess. The roller may extend substantially along the entirety of the recess and may have a variety of tread patterns. The container may further include more than one roller. More than one roller may be partially located within the recess of the container.

### FIELD OF TECHNOLOGY

The present disclosure relates generally to containers, and more particularly to movable containers that can be pulled or pushed by a person.

### BACKGROUND

People visit beaches around the world on a daily basis. Beachgoers often bring coolers for beverages and/or food. Present coolers are largely carried by hand, although some may have wheels. The wheels are often narrow, being designed for a hard surface, and sink into a sandy surface. Due to this, movement of the coolers through the sand of the beaches is literally a drag, and certainly is not optimal.

### SUMMARY

The present disclosure generally provides a movable container for transporting materials by a person. The container in one form includes a recess at a bottom end thereof. The recess may extend substantially along the width of the container. Within the recess is an elongated roller that may extend substantially along the entirety of the recess (i.e., substantially along the width of the container). The roller may have a variety of diameters/circumferences and may have a variety of tread patterns. Regardless, the roller is intended to present a substantial area of surface contact for supporting the container in a rolling manner as it traverses sand or other soft or fluent surfaces. The container may also include a resting portion located on the bottom of the container, distant from the roller, to support the container more or less level at rest. The container additionally has a handle used to displace the weight of and move the container.

The container may alternatively include more than one roller. For example, more than one roller may be located within the recess of the container. Here again, the plural rollers present a substantial area of surface contact. Additionally, a support may be implemented that creates more than one recess along the width of the container. In a further example, wheels may be implemented on the outside of the container to improve the container's maneuverability on solid surfaces. In yet another example, recesses may be located at both the front and back of the container, and each recess may correspond with at least one roller.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1A is a perspective view of a container including a roller according to the present disclosure;

FIG. 1B is a side view of the container of FIG. 1A including the roller according to the present disclosure;

FIG. 1C is a back view of the container of FIG. 1A including the roller according to the present disclosure;

FIG. 1D is a cross-section view of the container of FIG. 1A including the roller according to the present disclosure;

FIG. 2 is a back view of another container including multiple rollers according to the present disclosure;

FIG. 3 is a back view of yet another container including multiple rollers and a support according to the present disclosure;

FIG. 4 is a back view of a modified container including the roller as well as outboard wheels according to the present disclosure;

FIG. 5 is a side view of still a further container including multiple rollers according to the present disclosure;

FIG. 6A is a side view of a smooth roller according to the present disclosure;

FIG. 6B is a cross-section view of the smooth roller of FIG. 6A cut along line A-A according to the present disclosure;

FIG. 6C is an end view of the smooth roller of FIG. 6A according to the present disclosure;

FIG. 7A is a side view of a linear treaded roller according to the present disclosure;

FIG. 7B is an end view of the linear treaded roller of FIG. 7A according to the present disclosure;

FIG. 8A is a side view of a wrapped treaded roller according to the present disclosure;

FIG. 8B is an end view of the wrapped treaded roller of FIG. 8A according to the present disclosure;

FIG. 9A is a side view of a roller having treaded and non-treaded portions according to the present disclosure;

FIG. 9B is a cross-section view of the roller having treaded and non-treaded portions of FIG. 9A cut along line A-A according to the present disclosure;

FIG. 9C is a cross-section view of the roller having treaded and non-treaded portions of FIG. 9A cut along line B-B according to the present disclosure;

FIG. 9D is an end view of the roller having treaded and non-treaded portions of FIG. 9A according to the present disclosure;

FIG. 10 is a side view of a container including a roller according to the present disclosure;

FIG. 11 is a side view of a container including multiple rollers according to the present disclosure;

FIG. 12A is a side view of a container including a retractable roller in a retracted position according to the present disclosure;

FIG. 12B is a side view of the container of FIG. 12A including the retractable roller in an extended position according to the present disclosure.

### DETAILED DESCRIPTION

The detailed description of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the invention. Thus, the detailed description herein is presented for purposes of illustration only and not of limitation. For example, references to a singular embodiment may include plural embodiments, and references to more than one component may include a singular embodiment.

The present disclosure provides a movable container for transporting materials with the container in contact with the surface being traversed (versus being clutched and carried).

In one preferred form, the container includes a recess at a bottom end thereof that may extend substantially along a width of the container. An elongated, generally cylindrical roller is mounted for rotation within the recess. The roller may extend substantially along the entirety of the recess (i.e., substantially along the width of the container). The roller may be provided in a variety of diameters/circumferences and may have a variety of tread patterns, or none at all.

The container also includes a resting or support portion located on the bottom of the container, distant from the roller. This support is useful to place the container generally level at rest (being approximately the height that the roller may extend from the recess. The container further has a handle used by a person to pull the container. Of course, the handle could be provided to push the container.

The shape and interior of the container may be conventional, taking many forms typical for a container used to transport material, such as foodstuffs and refreshing beverages. Note that while the invention is described herein in the general environment of a beach-going container, it is not so limited in application. The container may be useful for other uses beyond that of a cooler, and the surface it rides upon or traverses could be grass or some other soft or fluent material.

The container may include more than one roller. For example, more than one roller may each be partially located within the recess of the container; partially in the sense that the roller(s) extends outboard from the recess so as to contact the surface below. Note also that the roller(s) could be mounted to the container bottom but not in a recess. This arrangement is not considered to be ideal, however, as this then presents a potential storage issue (with the roller extending substantially out from the container bottom).

In a further example, wheels may be located on the outside of the container to improve the container's maneuverability on solid surfaces. In yet another example, recesses may be located at both the front and back of the container, and each recess may correspond with at least one roller mounted for rotation therein.

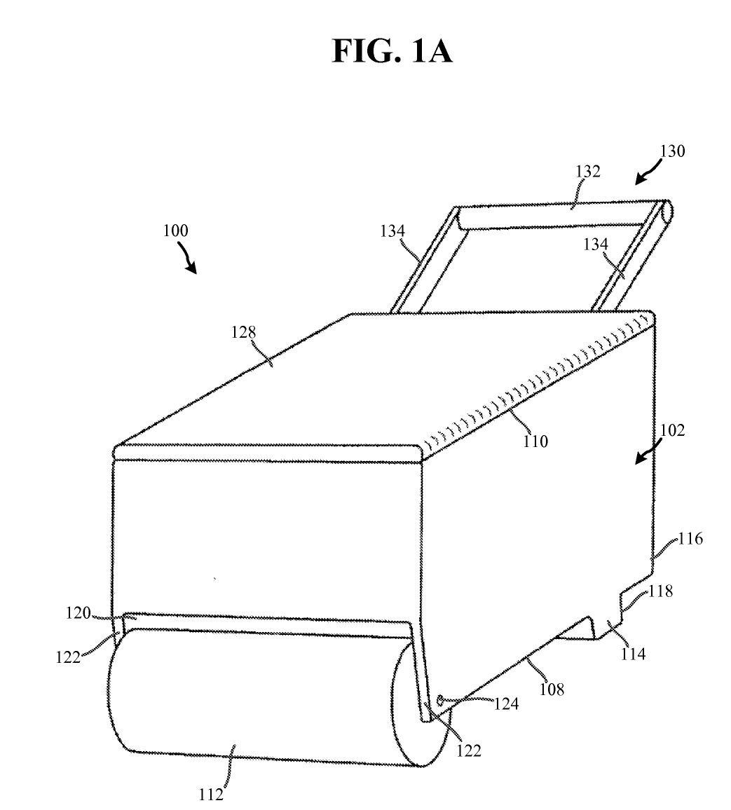

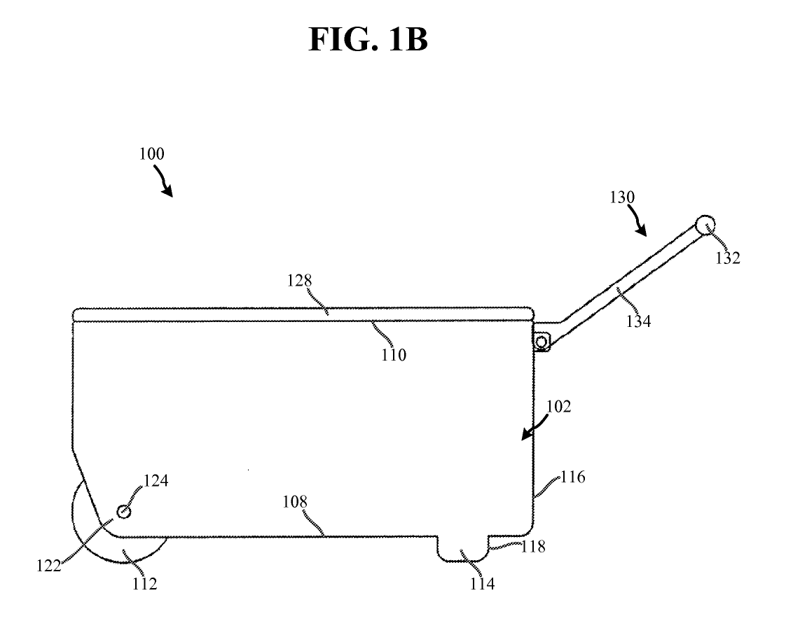

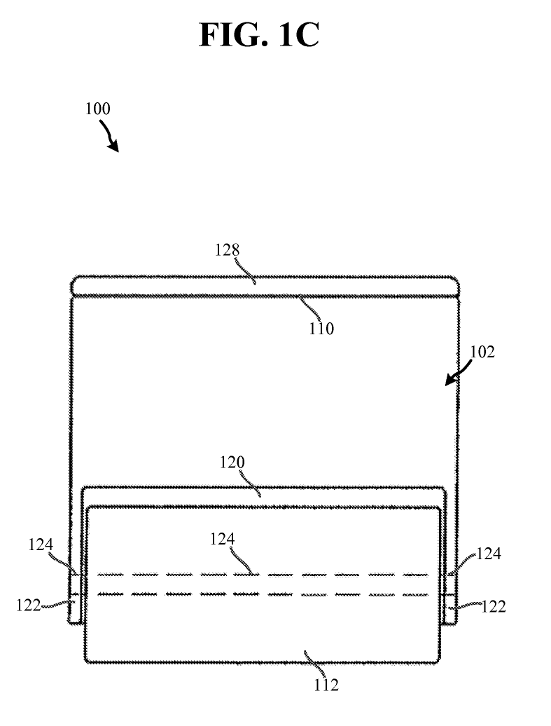

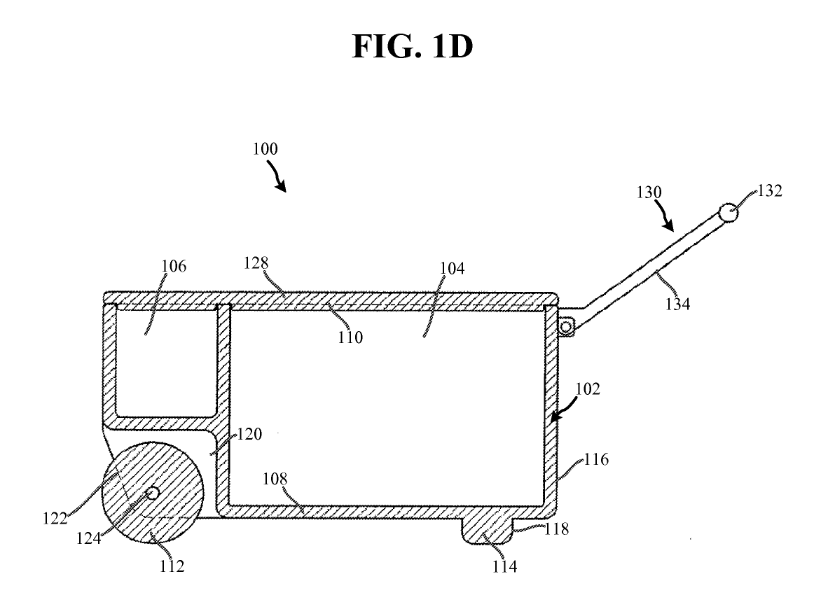

Referring to FIGS. 1A through 1D, a container 100 according to the present disclosure is described. The container 100 includes a main compartment 102 within which a variety of items may be stored. The main compartment 102 may include a first sub-compartment 104 that encompasses a majority of an internal area of the main compartment 102, and a second sub-compartment 106 that encompasses less than a majority of the internal area of the main compartment 102. The first sub-compartment 104 may be rectangular in shape and may extend from a bottom 108 of the main compartment 102 to a top 110 of the main compartment 102. In the example where the first sub-compartment 104 extends from the bottom 108 to the top 100 of the main compartment 102, the first sub-compartment 104 is not present above a roller 112 of the container 100. The second sub-compartment 106 may extend from the top 110 of the main compartment 102 to a location proximate to an upper area of the roller 112. For example, a bottom of the second sub-compartment 106 may be located proximate to a recess 120 of the main compartment 102 described in detail below. The main compartment 102, and specifically the sub-compartments 104, 106, may store items used/consumed at a beach such as sporting equipment, food, and beverages, for example.

Located on the exterior of the main compartment 102 is a resting portion 114 upon which the container 100 rests when the container 100 is stationary. The resting portion 114 may be located distant from or proximate an edge (i.e., front edge) 116 of the main compartment 102 (as illustrated in FIGS. 1A, 1B, and 1D). Alternatively, the resting portion 114 may be located at the front edge 116 of the main compartment 102 (i.e., a surface 118 of the resting portion 114 may be substantially or directly planar with the front edge surface 116 of the main compartment 102).

The main compartment 102 may additionally have a recess 120 located within a bottom end (i.e., back end) thereof. The recess 120 is located distal from the resting portion 114 along the bottom 108 of the main compartment 102. The recess 120 may be semi-circular in form, allowing for the roller 112 (as described herein below) to be partially or substantially wholly encompassed within the recess 120 without restricting movement of the roller 112. The recess 120 may extend substantially across a width of the main compartment 102.

The main compartment 102 may have two areas 122 where the roller 112 rotatably connects to the main compartment 102. The roller 112 may extend substantially along the length of the recess 120 (i.e., substantially along the width of the container 100). Coupling of the roller 112 to the main compartment 102 may include the use of one or more bearings (not illustrated), fasteners (not illustrated), and/or an axle 124. For example, fasteners as used herein may include nuts, bolts, screws, cotter pins, like fasteners not listed herein, and combinations thereof. Moreover, the roller 112 may be coupled to the main compartment 102 in a manner that provides for easy removal and installation of various rollers 112. This allows for rollers 112 to be interchanged on the container 100 depending on environment conditions and terrain considerations.

A lid 128 is movably coupled to the top 110 of the main compartment 102. The lid 128 may slide or rotate with respect to the main compartment 102 during opening and closing of the container 100.

A handle 130 is also coupled to the main compartment 102. The handle 130 may be coupled to the main compartment 102 in a manner that prevents the handle 130 from moving with respect to the main compartment 102. Alternatively, the handle 130 may be coupled to the main compartment 102 in a manner that allows the handle 130 to rotate or slide with respect to the main compartment 102. The handle 130 may be coupled to the main compartment 102 using fasteners such as nuts, bolts, screws, cotter pins, like fasteners not listed herein, and combinations thereof, for example. Movability of the handle 130 with respect to the main compartment 102 may provide for increased leverage during maneuverability of the container 100 and increased compactness of the container 100 while the container 100 is stationary or being stored. As illustrated, the handle 130 has a grip portion 132 and two supports 134 coupled to ends of the grip portion 132 and the main compartment 102. However, one skilled in the art should appreciate that the handle 130 may include more or less than two supports 134 and that the supports 134 may be coupled to areas of the grip portion 132 other than ends as illustrated in FIG. 1A.

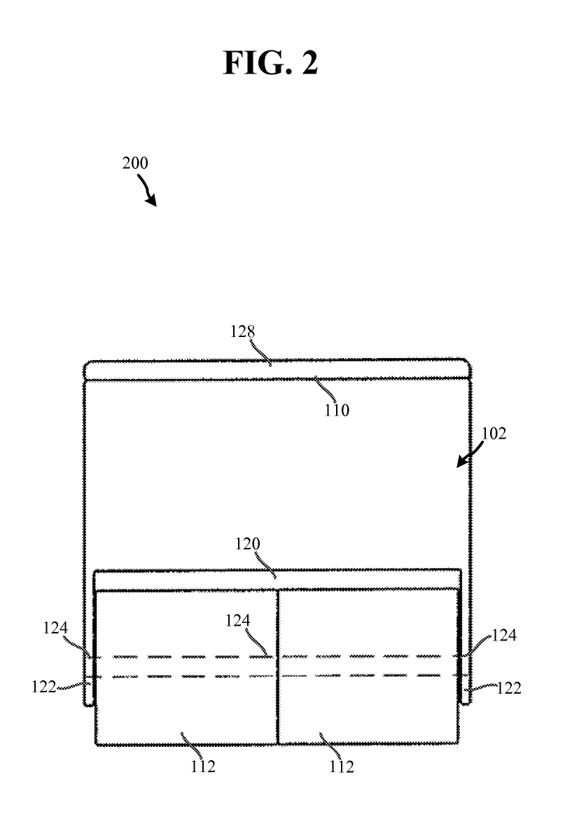

Referring now to FIG. 2, an illustrative embodiment of the container 200 is described. The container 200 may be identical to the container 100 as described with respect to FIGS. 1A through 1D, except the container 200 includes two rollers 112 located in the recess 120. The rollers 112 may or may not have identical or substantially identical lengths (as measured along the axle 124). Additionally, the rollers 112 may or may not have identical treads as described in detail herein below.

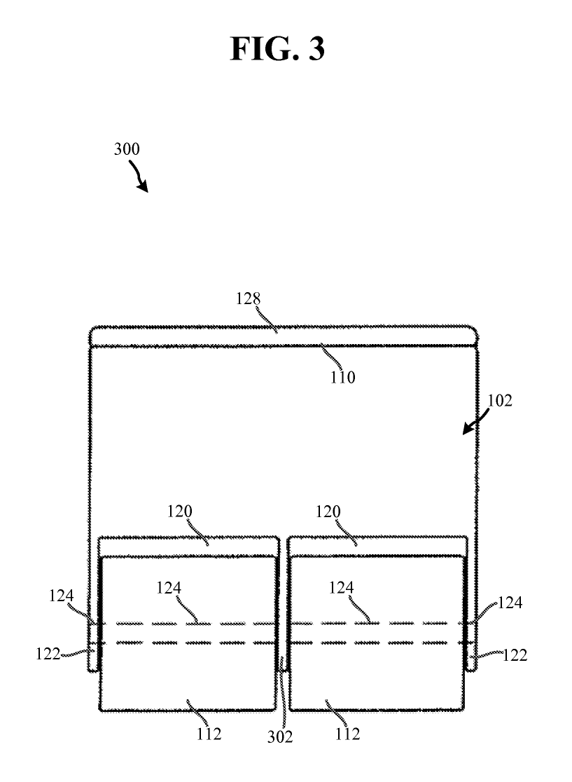

FIG. 3 illustrates another illustrative embodiment of the container 300 according to the present disclosure. The container 300 may be identical to the container 100 as described with respect to FIGS. 1A through 1D, except the container 300 includes two recesses 120 that each house a roller 112. A support 302 is located between the rollers 112. Each recess 120 is partially created by the support 302 and an area 122 where a roller 112 rotatably connects to the main compartment 102. A single axle 124 may connect both rollers 112 to the main compartment 102 and the support 302, or each roller 112 may be connected to the container 300 by its own respective axle 124. The support 302 may be located along a width of the main compartment 102 that dictates each roller 112 have an identical or substantially identical length (as measured along the axle 124). However, one skilled in the art should appreciate that the support 302 may be at a location along the width of the container 300 that dictates the rollers 112 having unsubstantially equal lengths without departing from the scope of the present disclosure. Additionally, the rollers 112 may or may not have identical treads as described in detail herein below.

As illustrated in FIGS. 2 and 3, the containers 200, 300 are equipped with two rollers 112. However, it should be appreciated that the containers 200, 300 may be configured to include more than two rollers 112. With specific reference to FIG. 3, if more than two rollers 112 are implemented, more than one support 302 may be implemented according to the teachings of the present disclosure.

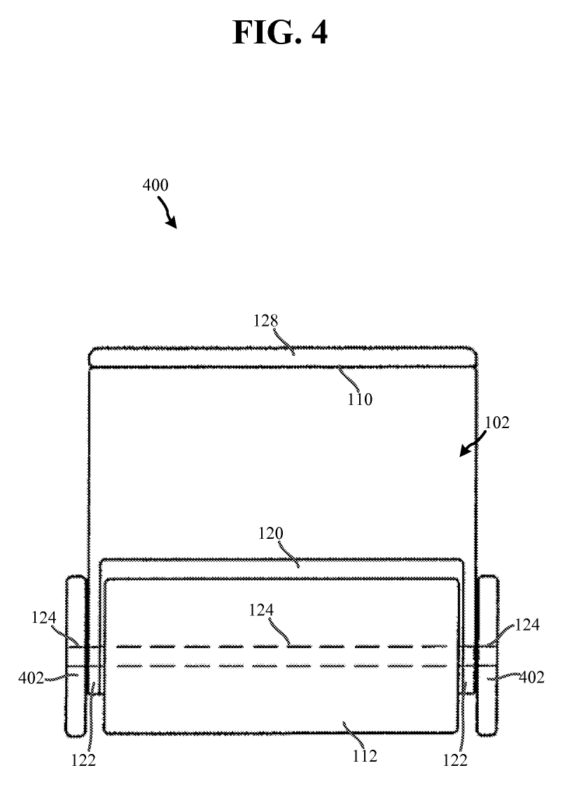

Attention is now given to FIG. 4, which illustrates a further illustrative embodiment of the container 400 according to the present disclosure. The container 400 may be identical to the container 100 as described with respect to FIGS. 1A through 1D, except the container 400 additionally includes a pair of wheels 402 located on exterior sides of the main compartment 102. A single axle 124 may connect the roller 112 and the wheels 402 to the main compartment 102, or each wheel 402 may be connected to the container 400 by its own respective axle 124. Implementation of the wheels 402 allows the container 400 to be maneuvered with relative ease on solid surfaces. Accordingly, the wheels 402 may have substantially or perfectly smooth surfaces/treads. Each wheel 402 may or may not have an identical tread with respect to the other wheel 402, and the wheels 402 may or may not have identical treads to that of the roller 112. While FIG. 4 illustrates a single roller 112 implementation, one skilled in the art should appreciate that more than roller 112 may be used. For example, the roller 112 configurations of FIGS. 2 and 3 may be implemented within the container 400 of FIG. 4.

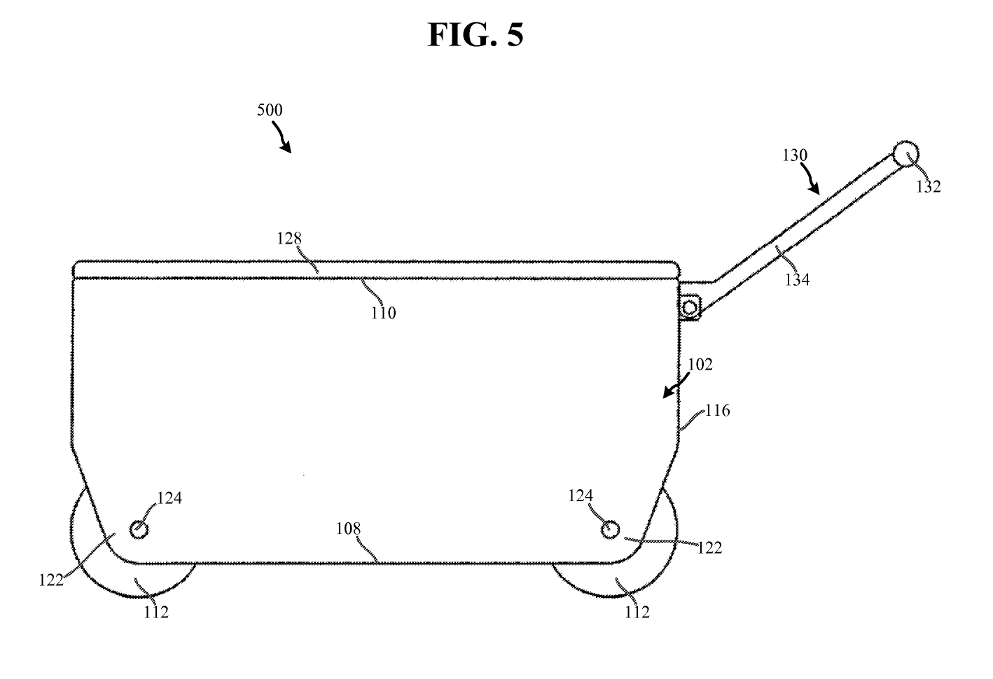

FIG. 5 illustrates yet another illustrative embodiment of the container 500 according to the present disclosure. The container 500 may be identical to the container 100 as described with respect to FIGS. 1A through 1D, except the container 500 includes a second recess 120 and a roller 112 located at the front/handle end of the container 500. Since the second roller 112 is used, the resting portion 114 may be omitted from this illustrative embodiment, resulting in the entirety of the container's weight resting upon the rollers 112 at all times. The rollers 112 of FIG. 5 may be implemented according to one or many of the teachings of FIGS. lA through 4.

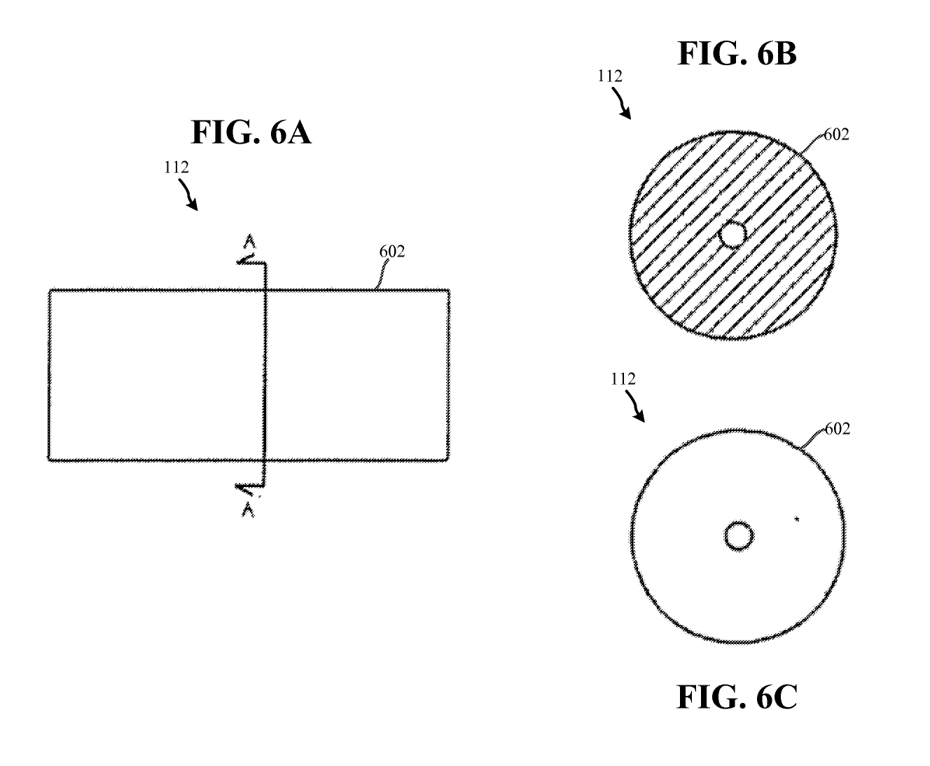

Attention is now given to FIGS. 6A through 6C, which illustrate an illustrative roller 112 according to the present disclosure. The roller 112 may have a substantially smooth or perfectly smooth surface 602. This allows the containers 100, 200, 300, 400, 500 to be maneuvered on solid surfaces with ease and little to no vibration.

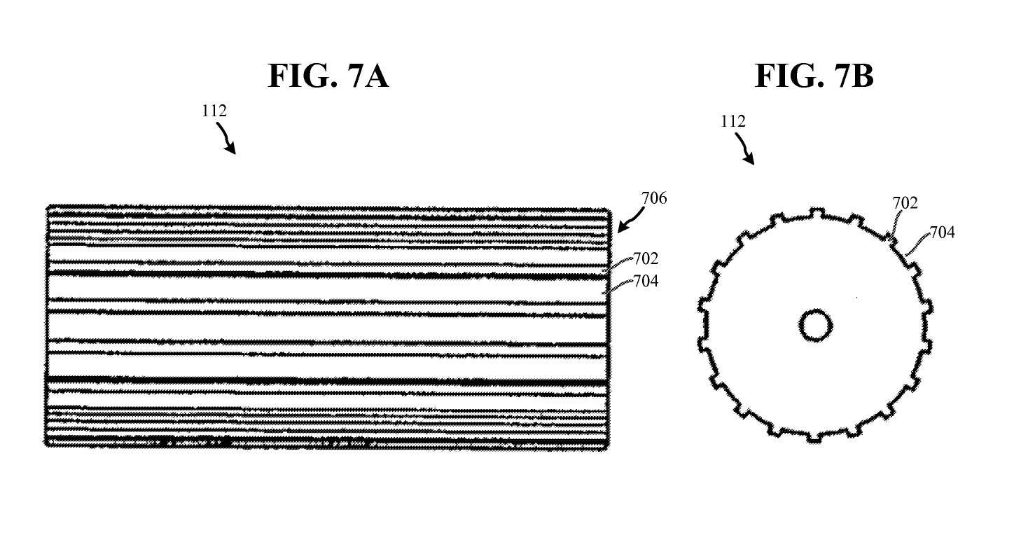

Referring now to FIGS. 7A and 7B, an illustrative roller 112 according to the present disclosure is described. The roller 112 may include a tread comprised of linear extensions 702 that create linear crevices 704. Put another way, the extensions 702 and crevices 704 orthogonally mate with ends/edges 706 of the roller 112. As illustrated, the extensions 702 have smaller widths than the crevices 704. However, it should be appreciated that the extensions 702 may have larger widths than the crevices 704, or the extensions 702 and crevices 704 may have equal or substantially equal widths, without departing from the scope of the present disclosure. The roller tread disclosed in FIGS. 7A and 7B may be beneficial when rolling the containers 100, 200, 300, 400, 500 through/on non-solid, displaceable (e.g., sand) or solid materials (e.g., cement or concrete).

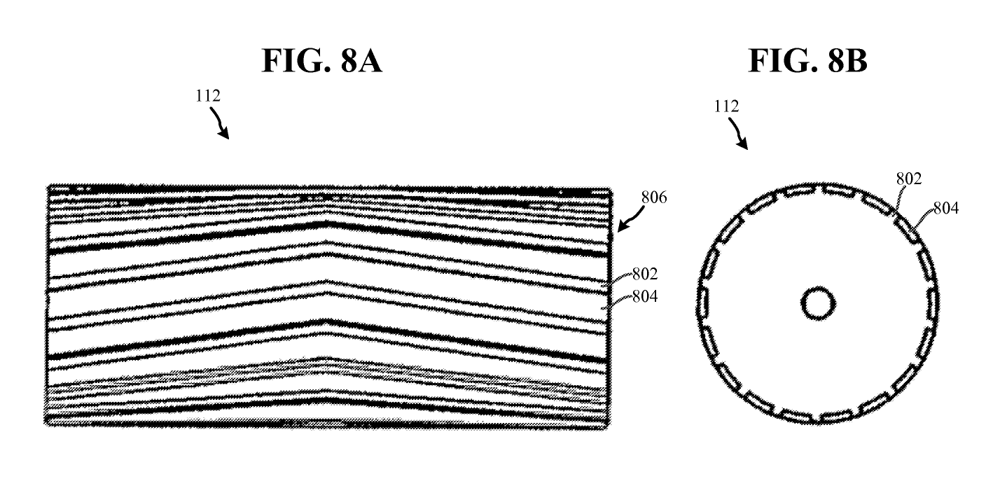

FIGS. 8A and 8B illustrate an illustrative roller 112 according to the present disclosure. The roller 112 may include a tread comprised of extensions 802 and crevices 804 “wrapped around” the roller 112. Each extension 802 and crevice 804 has two linear portions that form an angle at or near a center of a width of the roller 112. Put another way, each portion of an extension 802 or crevice 804 angularly extends from an edge/end 806 of the roller 112 towards a location centrally located along the width of the roller 112, where corresponding portions of an extension 802 or crevice 804 meet to form an angle. As illustrated, the extensions 802 have smaller widths than the crevices 804. However, it should be appreciated that the extensions 802 may have larger widths than the crevices 804, or the extensions 802 and crevices 804 may have equal or substantially equal widths, without departing from the scope of the present disclosure. The roller tread disclosed in FIGS. 8A and 8B may be beneficial when rolling the containers 100, 200, 300, 400, 500 through/on non-solid or solid materials.

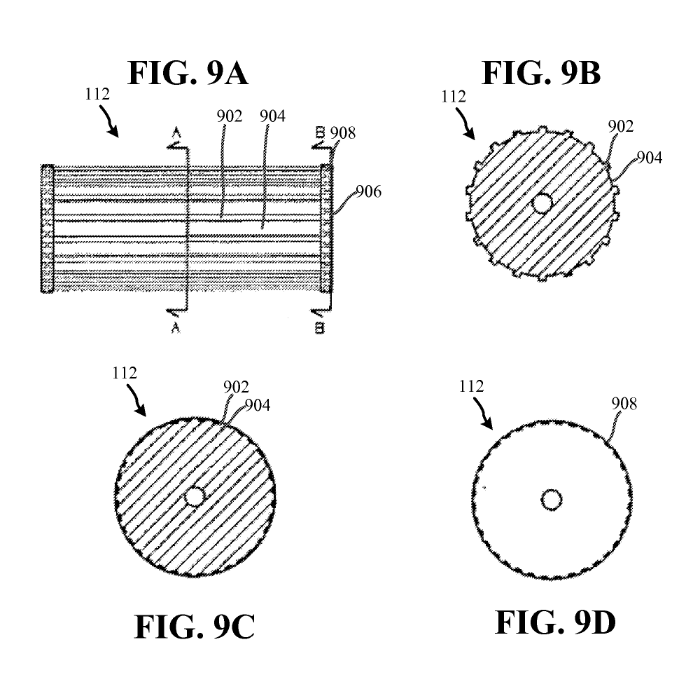

FIGS. 9A through 9D illustrate a further roller 112 according to the present disclosure. The roller 112 may include a tread comprised of linear extensions 902 and linear crevices 904 that are orthogonal with respect to ends/edges 906 of the roller 112. As illustrated, the extensions 902 have smaller widths than the crevices 904. However, it should be appreciated that the extensions 902 may have larger widths than the crevices 904, or the extensions 902 and crevices 904 may have equal or substantially equal widths without departing from the scope of the present disclosure. Furthermore, while the extensions 902 and crevices 904 are illustrated as being linear, one skilled in the art should appreciate that the extensions 902 and crevices 904 may be non-linear and may be non-orthogonal with respect to the edge 906 (such as the extensions 802 and crevices 804) without departing from the present disclosure. The roller's tread may also include a smooth or substantially smooth surface 908 located at the ends/edges 906 of the roller 112. For example, the surface 908 may be entirely smooth. In another example, the surface 908 may have a tread pattern, but one that is less aggressive than the tread pattern of the rest of the roller 112. The rigid portion of the tread (i.e., the extensions 902 and crevices 904) assist in the movement of the containers 100, 200, 300, 400, 500 through non-solid materials and the smooth or substantially smooth surface 908 assists in movement of the containers 100, 200, 300, 400, 500 along solid surfaces with little to no vibration.

In an unillustrated example, the roller 112 may include a non-solid, lattice tread. This could take the form of a mesh or screen-like material formed into a cylindrical shape. The lattice tread may include extensions (such as the extensions 702, 802, 902 described herein) to allow the roller 112 to move through non-solid, displaceable materials. Additionally, the lattice treaded roller 112 may also include a smooth surface (such as the smooth surface 908) to allow the roller 112 to also roll along solid materials (e.g., concrete and cement) with little to no vibration.

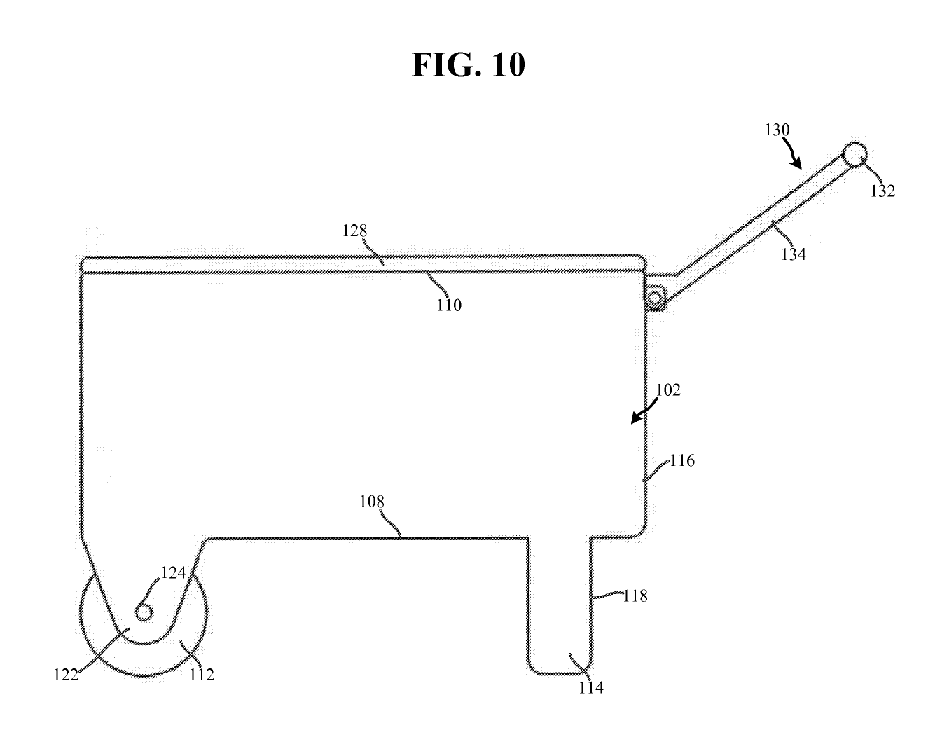

FIG. 10 illustrates an embodiment of the container according to the present disclosure. The container includes an elongated resting portion 114 and an elongated area 122 where the roller 112 rotatably connects to the main compartment 102. The elongated resting portion 114 has a length that results in a bottom of the elongated resting portion 114 being horizontal with a bottom of the roller 112. As elongation of the resting portion 114 and the area 122 increases, a center of gravity of the container raises. As the container's center of gravity raises, the container becomes easier to tip, and potentially harder to maneuver. Thus, one skilled in the art should appreciate that the resting portion 114 and the area 122 may have various elongations depending upon the construct of the container and user preferences.

As illustrated, the area 122 has an elongation that results in the roller 112 being entirely bellow the main compartment 102. However, one skilled in the art should appreciate that the area's elongation may result in a portion of the roller 112 being located within the main compartment 102. Furthermore, as illustrated, a back of the roller 112 is vertically in-line with a back of the main compartment 102. However, the back of the roller 112 may be configured to not be vertically in-line with the back of the main compartment 102 without departing from the present disclosure.

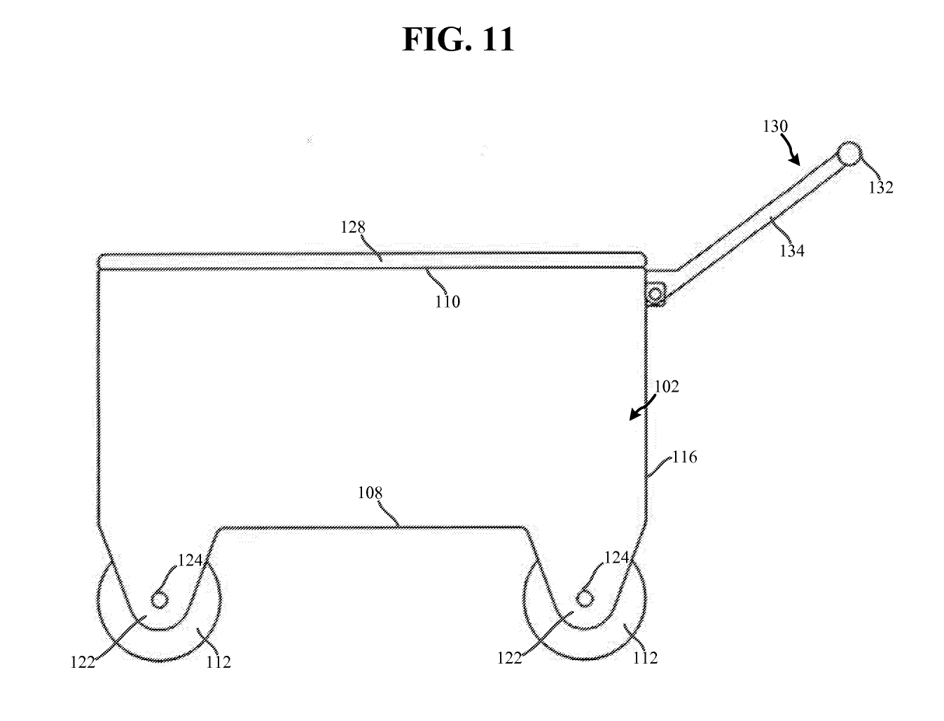

FIG. 11 illustrates another embodiment of the container according to the present disclosure. This embodiment includes two elongated areas 122 whereby rollers 112 rotatably connect to the main compartment 102. Each elongated area 122 may have an identical length, resulting in the bottom of the rollers 112 being horizontally in-line. As the elongation of the areas 122 increase, a center of gravity of the container raises. As the container's center of gravity raises, the container becomes easier to tip, and potentially harder to maneuver. Thus, one skilled in the art should appreciate that the areas 122 may have various elongations depending upon the construct of the container and user preferences. As illustrated, the areas 122 have elongations that result in both of the rollers 112 being entirely bellow the main compartment 102. However, one skilled in the art should appreciate that the areas' elongations may result in a portion of one or both of the rollers 112 being located within the main compartment 102. Furthermore, as illustrated, a back of one of the rollers 112 is vertically in-line with a back of the main compartment 102 and a back of the other roller 112 is vertically in-line with the front edge 116 of the main compartment 102. However, one or both of the rollers 112 may be configured to not be vertically in-line with edges of the main compartment 102 without departing from the present disclosure.

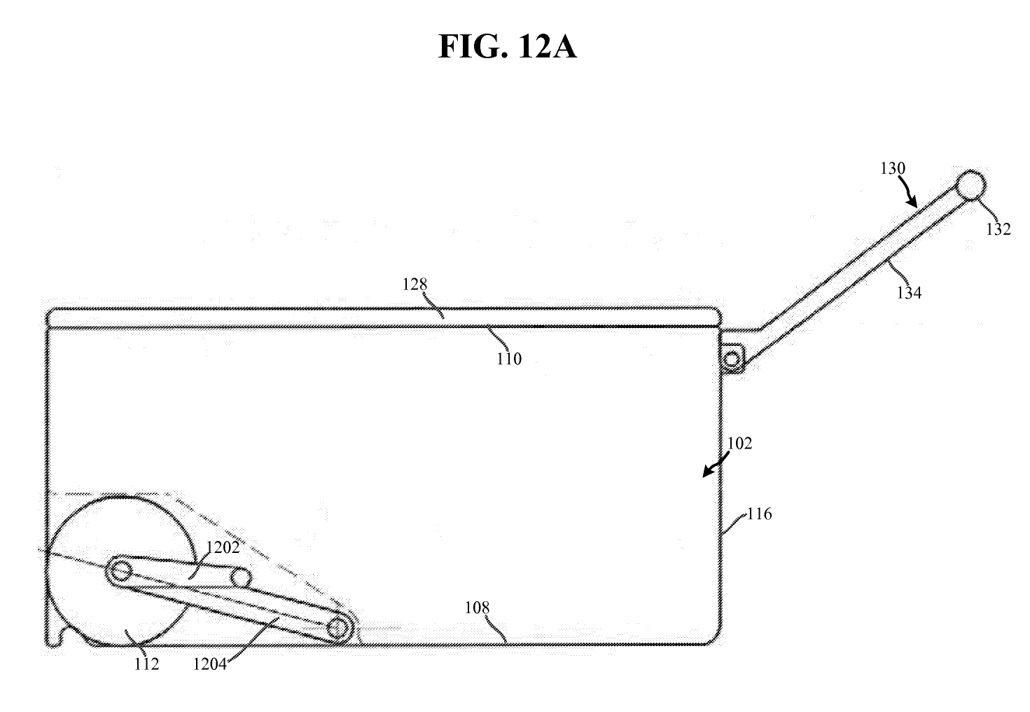

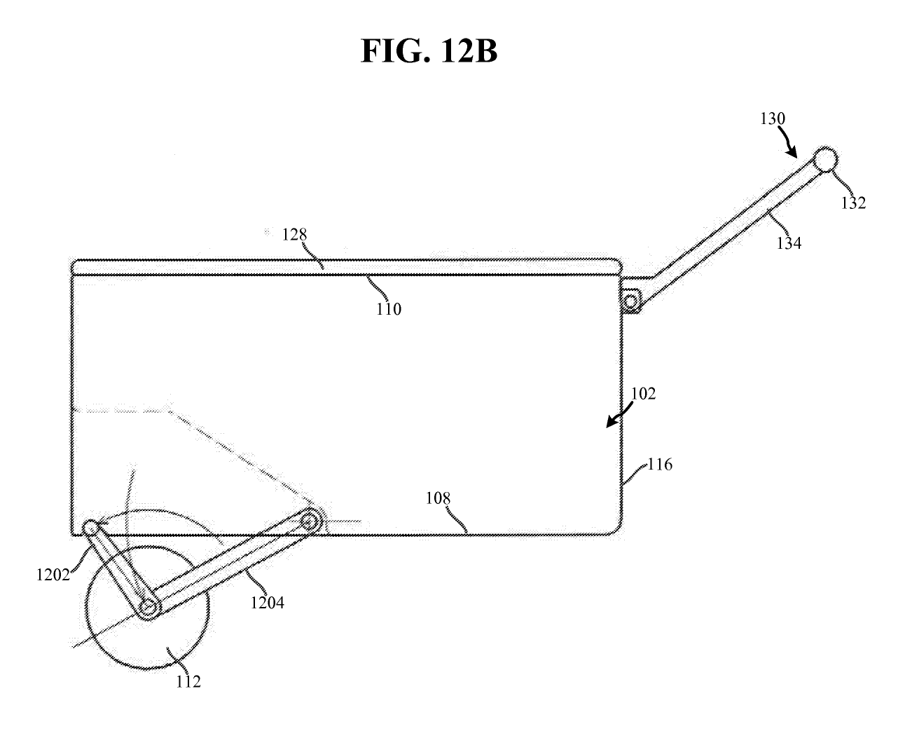

FIGS. 12A and 12B illustrate yet another embodiment of the container of the present disclosure. The container includes a retractable roller 112. As illustrated, the container only contains one retractable roller 112. However, more than one retractable roller 112 may be implemented at various locations along bottom 108 of the main compartment 102. As illustrated, the roller 112 is retractably coupled to the main compartment 102 via two arms 1202, 1204. However, one skilled in the art should appreciate that more or less than two arms may be used. The arms 1202, 1204 may have substantial equal or substantially unequal lengths depending upon implementation.

The roller 112 may be in a retracted position (illustrated in FIG. 12A) or an extended position (illustrated in FIG. 12B). While in the retracted position (used when the container is to remain stationary), the roller 112 may be positioned entirely within a recess of the main compartment 102. When this occurs, it may be beneficial for the container to not have a resting portion 114 in order to ensure the container is as close to horizontal when it is stationary. When the roller 112 is in the extended position, the arms 1202, 1204 may be orthogonal with respect to each other. This limits the amount of weight load-bearing experienced by the arms 1202, 1204. Yet, one skilled in the art should appreciate that the arms 1202, 1204 may be non-orthogonal in the extended position if desired. Moreover, the roller 112 may be positioned entirely below the main compartment 102 when in the extended position (as illustrated in FIG. 12B). However, alternatively, a portion of the roller 112 may remain within the recess of the main compartment 102 when the roller 112 is in the extended position.

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

1. A container for transporting materials, comprising:
a base having a main compartment formed thereon;
a part formed on the base adapted to be grasped by a person for moving the container;
a recess within a bottom corner of the base; and
an elongated roller coupled to the base and at least partially within the recess, the roller having an exterior surface presenting a substantial area for rolling contact over terrain over which the container may traverse, the roller extending substantially along a width of the recess.

2. The container of claim 1, wherein the roller has a linear tread pattern.

3. The container of claim 1, wherein the roller has a wrapped tread pattern.

4. The container of claim 1, wherein the roller has a tread pattern and substantially smooth surfaces located at ends of the roller.

5. The container of claim 4, wherein the tread pattern is a linear tread pattern.

6. The container of claim 4, wherein the tread pattern is a wrapped tread pattern.

7. The container of claim 1, further comprising:
a protrusion located on a bottom surface of the main compartment distant from the recess, the protrusion supporting weight of the container when the container is stationary.

8. The container of claim 7, wherein the recess is distal from a protrusion along the bottom surface of the base.

9. The container of claim 1, wherein two rollers are coupled to the base, the two rollers collectively extending substantially along the width of the recess.

10. The container of claim 9, further comprising:
a support located through at least a portion of the recess, the support being located between the two rollers.

11. The container of claim 1, further comprising:
a wheel located near an exterior surface of the base proximate a lateral end of the roller.

12. The container of claim 1, further comprising:
a second recess located within a front bottom corner of the main compartment; and
a second roller coupled to the main compartment and partially located within the second recess.

13. A container that can be pushed or pulled by a person over a surface where the surface may be soft or fluent, such as sand or grass, comprising:
a box-like construct forming a main container having a base and sidewalls, and defining an interior space therein for contents to be carried by the container;
a part formed on the base adapted to be grasped by a person for moving the container, as by pushing or pulling; and
at least one elongated roller coupled to the base in a manner to rotate while supporting the container, the roller having an exterior surface presenting a substantial area for rolling contact over terrain over which the container may traverse, the roller extending substantially along a width of the base.

14. The container of claim 13, wherein a recess is formed extending along the width of the base, and the at least one roller is at least partially within the recess.

15. The container of claim 13, wherein the at least one elongated roller is coupled to the base at a distance from the box-like construct.

16. The container of claim 15, wherein the at least one elongated roller is located entirely below the box-like construct.

17. The container of claim 13, wherein the at least one elongated roller is retractably coupled to the base.

18. The container of claim 17, wherein the at least one elongated roller is retractably coupled to the base by two arms.

19. The container of claim 18, wherein the wherein the two arms are substantially orthogonal when the at least one elongated roller is in an extended position.

20. The container of claim 17, wherein the at least one elongated roller is located entirely within the box-like construct when the at least one elongated roller is in a retracted position.
